(19) United States
(12) Patent Application Publication
(10) Pub. No.: US 2006/0123363 A1
(43) Pub. Date: Jun. 8, 2006

(54) Method and apparatus for automated design of quantum circuits

(76) Inventors: Colin P. Williams, Half Moon Bay, CA (US); Lin Song, Boulder, CO (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/007,638

(22) Filed: Dec. 7, 2004

(51) Int. Cl. G06F 17/50

(52) U.S. Cl. 716/1; 977/839

(57) ABSTRACT

The present invention provides an algebraic approach to quantum circuit design based on using a GSVD (Generalized Singular Value Decomposition) to map a unitary matrix, representing a desired quantum computation, into a product of block diagonal unitary matrices, each of which can then be mapped into equivalent circuit fragments. The invention describes a number of rules allowing such circuits to be compactified.

### RELATED APPLICATION

The applicant claims priority to provisional patent application No. ______ filed on Dec. 2, 2004, entitled “METHOD AND APPARATUS FOR AUTOMATED DESIGN OF QUANTUM CIRCUITS” and naming inventors Colin P. Williams and Lin Song.

### BACKGROUND OF THE INVENTION

1. Field of the Invention

The present invention relates to the field of quantum computing and the automatic generation of circuits.

Portions of the disclosure of this patent document contain material that are subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Traditional (also sometimes referred to as “classical”) computers typically rely on binary state devices (on/off, high/low, open/closed) as the fundamental logical building block. Storage of data is accomplished by grouping bits of binary signals into meaningful logical representations in digital memory. Transistors are combined in arrays so that by selectively turning them on or off, logical operations can be accomplished on binary data.

Another type of computing has been developed referred to as “quantum” computing. In a quantum computer, the fundamental unit of information (called a quantum bit or qubit), is not binary but rather more quaternary in nature. This qubit property arises as a direct consequence of its adherence to the laws of quantum mechanics which differ from the laws of classical physics. A qubit can exist not only in a state corresponding to the logical state 0 or 1 as in a classical bit, but also in states corresponding to a blend or superposition of these classical states. In other words, a qubit can exist as a zero, a one, or simultaneously as both 0 and 1, with a numerical coefficient which when squared in absolute value, represents the probability for each state.

In a traditional computer, information is encoded in a series of bits, and these bits are manipulated via Boolean logic gates arranged in succession to produce an end result. Similarly, a quantum computer manipulates qubits by executing a series of quantum gates, each a unitary transformation acting on a single qubit or pair of qubits. In applying these gates in succession, a quantum computer can perform a complicated unitary transformation to a set of qubits in some initial state. The qubits can then be measured, with this measurement serving as the final computational result. This similarity in calculation between a classical and quantum computer affords that in theory, a classical computer can accurately simulate a quantum computer, but only inefficiently. In other words, a classical computer should be able to do anything a quantum computer can do. However, the practicalities of implementing quantum processes on a classical computer limit such applications. It is preferable to construct a quantum computer using quantum gates and devices to perform quantum computations.

A quantum computation can be regarded as a controlled physical evolution that carries an initial quantum state, encoding some computational problem of interest, into a final quantum state that, when measured, reveals a solution to the problem with non-negligible probability. This abstraction conceals a difficult problem that experimentalists must face, namely, how to decompose the required transformation into a sequence of one and two-qubit quantum gate operations. For specially structured transformations, such as the Quantum Fourier Transform (QFT), compact quantum circuits are already known and can be done by hand. However, the decomposition of more complicated transformations rapidly becomes too complex to do by hand.

This means that quantum circuit decompositions of arbitrary unitary operators are not feasible, limiting many applications. For example, the quantum circuit decomposition of an arbitrary unitary matrix can be used to determine an optimal pathway for the direct synthesis of any pure or mixed quantum state, and to perfectly simulate high-dimensional stochastic processes that are hard to do faithfully using classical pseudo-random number generators. Moreover, in prior art approaches such as Grover's algorithm, if one has prior knowledge of the approximate location of the solution state(s) one can use a biased amplitude amplification operator which tends to pump probability amplitude preferentially into eigenstates in the presumed region of the solutions. Such a unitary matrix may not have any special structure, making its quantum circuit hard to guess and design.

Moreover, although the set of gates used in such quantum circuits has traditionally been taken to be the set of all one-qubit quantum gates in conjunction with controlled-NOT (CNOT), many equally good universal gate sets exist, and there might be advantages in using a non-standard gate set if certain choices happen to be easier to realize in one hardware context than another. For example, in the context of spin-based quantum computing, fractional powers of the two-qubit exchange interaction (i.e., the SWAP gate) are known to be as powerful as CNOT as far as computational universality is concerned. Likewise, in the context of charge-based quantum computing, the two-qubit gate iSWAP is easier to realize than CNOT and yet is equally as powerful computationally. It makes sense therefore, to tailor the decomposition of a unitary operator to fit the chosen physical hardware, rather than to wrestle the physics to fit an ad hoc model of computation.

It is desired, therefore, to design quantum circuits that implement desired quantum computations. In the prior art there have been a number of methods devised for designing quantum circuits, including human ingenuity, exhaustive enumeration, genetic algorithms, and algebraic decomposition.

Human Ingenuity:—Most researchers do not use any formal scheme, but instead rely upon trial and error, and human ingenuity, to arrive at a quantum circuit decomposition of a unitary matrix (i.e., a circuit design for a desired quantum computation) by hand. This approach is feasible for specially structured unitary matrices such as the Quantum Fourier Transform, and the quantum wavelet transform, because the special structure of these unitary operators reflects regular and predictable structures in the equivalent quantum circuits, thereby making the design job easier. However, for other implementations, this approach is too time consuming and may not yield an optimized result.

Exhaustive Enumeration: Another prior art approach enumerates the space of possible circuit designs of increasing complexity exhaustively starting from the empty circuit. For each topologically distinct circuit design, a computer finds optimal values for the parameters of all parameterized-gates in the circuit. When the search reaches a viable circuit topology, this method finds the smallest circuit sufficient to implement the desired unitary operator. However, exhaustive enumeration composed with numerical optimization may be computationally intractable because the number of possible quantum circuit topologies grows exponentially with increasing numbers of gates in the circuit. Hence the method is only feasible for unitary operators that in fact have compact circuit descriptions.

Genetic Algorithms: A third approach to quantum circuit design uses genetic algorithms to breed a quantum circuit that achieves a desired unitary transformation. A random population of circuits is created, and each is assigned a “fitness” value that is a measure of how closely the circuit comes to achieving the desired unitary operator. Pairs of circuits are selected for breeding in proportion to their fitness and then mutation and crossover operations applied to make a new generation of circuits. By iterating this process one converges on a population of circuits that tend towards implementing the desired unitary operator. For genetic algorithms to work well, one needs a degree of decomposability in the problem i.e., it must be possible to determine that part of the solution is correct while ignoring the rest. Because of the way the direct (also known as “tensor” or “Kroenecker”) product of matrices tends to spread elements throughout the resulting matrix, it may be difficult for a genetic algorithm to find satisfactory circuits for highly entangling unitary operators.

Algebraic Decomposition: Another prior art approach to finding quantum circuit decomposition of an arbitrary unitary matrix is to apply a recursive algebraic decomposition procedure such as the progressive diagonalization of Reck and the hierarchical CS decomposition of Tucci. Algebraic factorization may work, but can result in quantum circuits that are exponentially large.

### SUMMARY OF THE INVENTION

The present invention provides an algebraic approach to quantum circuit design based on using a GSVD (Generalized Singular Value Decomposition) to map a unitary matrix, representing a desired quantum computation, into a product of block diagonal unitary matrices, each of which can then be mapped into equivalent circuit fragments. The invention describes a number of rules allowing such circuits to be compactified. The system also provides a method to decompose block diagonal matrices into quantum circuit fragments for n qubits. The system may be extended to design quantum circuits that use alternative 2-qubit gate primitives (e.g., iSWAP and Sqrt(SWAP)), instead of just controlled-NOT gates. The system can process permutation matrices and Fredkin and Toffoli gates. As a result, it is possible to encode exponentially many classical bits into polynomially many qubits, thereby providing a method for entering data into a quantum computer. The system makes it possible to compute a quantum circuit sufficient to create any quantum state of n-qubits, thereby providing a mechanism for creating for creating arbitrary pure or mixed quantum states. The invention describes the mathematics of mapping a block diagonal matrix of 1-qubit phase gates into an equivalent quantum circuit. All cases can be extended to the n-qubit case.

### BRIEF DESCRIPTION OF THE DRAWINGS

These and other features, aspects and advantages of the present invention will become better understood with regard to the following description, appended claims and accompanying drawings where:

FIG. 1 illustrates a quantum circuit for a block diagonal operator.

FIG. 2 illustrates a quantum circuit for an embodiment of a unitary operator.

FIG. 3 illustrates a quantum circuit with a substitution in place as a two-qubit gate.

FIG. 4 illustrates a quantum circuit using another substitution.

FIGS. 5A and 5B illustrate the optimal quantum circuit for each maximally-entangling permutation matrix.

FIG. 6 illustrates the optimal quantum circuit for the non-entangling permutation matrices.

FIG. 7 illustrates an optimal quantum circuit for a given permutation matrix.

FIG. 8 illustrates an embodiment of the quantum circuit of FIG. 7.

FIG. 9 illustrates another embodiment of the quantum circuit of FIGS. 7 and 8.

FIG. 10 is a block diagram of the structure of the circuits of FIGS. 8 and 9.

FIG. 11 illustrates an embodiment of a rule of the circuit equality of FIG. 10.

FIG. 12 illustrates a quantum circuit that is a naïve factorization of a function.

FIG. 13 illustrates a quantum circuit that is an efficient representation of the function of the circuit of FIG. 12.

FIG. 14 illustrates a quantum circuit created using algebraic decomposition without compactification.

FIG. 15 illustrates the quantum circuit of FIG. 14 with a compactifcation rule applied.

FIG. 16 illustrates a quantum circuit that is a raw output of an algebraic decomposition without compactification.

FIG. 17 illustrates the quantum circuit of FIG. 16 with a compactification rule applied.

FIG. 18 illustrates the quantum circuit of FIG. 17 with an alternate compactification rule applied.

FIG. 19 is a flow diagram illustrating the operation of an embodiment of the invention.

FIG. 20 is a flow diagram illustrating an embodiment of decomposition of the present invention.

FIG. 21 illustrates a random unitary matrix.

FIG. 22 represents the decomposition of the matrix of FIG. 21.

FIG. 23 illustrates quantum circuits representing the three matrices of FIG. 22.

FIG. 24 is a concatenation of the quantum circuits of FIG. 23.

FIG. 25 is an example unitary matrix with four block diagonal matrices.

FIG. 26 is a block diagram of a conditional quantum logic circuit of the matrices of FIG. 25.

FIG. 27 is a block diagram of a special case conditional quantum logic circuit of the matrices of FIG. 25.

### DETAILED DESCRIPTION OF THE INVENTION

The embodiments of the present invention are a method and an apparatus for automatic generation of quantum circuits. In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention.

A quantum algorithm amounts to a specification of a desired unitary transformation to be performed on some set of quantum bits (qubits). To perform this transformation on real quantum computing hardware one needs to break it down into a sequence of manageable steps involving operations on single qubits and, in one embodiment, pairs of qubits at a time. This decomposition is called a quantum circuit decomposition of the associated unitary transformation. Unfortunately, it is not always feasible to do this decomposition by hand, because the unitary transformation may have no obvious structure that makes is easy to see what its circuit will be. Similarly, there can be too many circuit topologies to try exhaustively, ands the genetic algorithm approach may never converge on a solution because the global fitness maximum is hidden by surrounding local fitness maxima—making any hill-climbing approach difficult.

A systematic algebraic approach to quantum circuit design is used in the present invention to find a quantum circuit for an arbitrary unitary transformation. Moreover, to make quantum algorithms which can process data, a method for entering such data into a quantum computer is needed. The quantum circuit design problem and the data entry problem can be considered to be related: In the invention, the scheme for designing a quantum circuit for a given unitary matrix can be adapted into a scheme to enter data into a quantum computer. The invention defines a quantum algorithm which could be implemented in one of several physical embodiments, e.g., spin-based quantum computing hardware (spintronics), charge-based quantum computing hardware, optical quantum computing hardware, or superconducting quantum computer hardware. The invention allows an exponential number of classical bits to be encoded in just a polynomial number of quantum bits. The method is constructive and deterministic.

The present invention provides a method and apparatus for recursive algebraic factorization of an arbitrary unitary operator. The invention can decompose any 2ⁿ×2ⁿ dimensional unitary operator into a product of 2ⁿ×2ⁿ dimensional block diagonal matrices, in which the blocks are all 2×2 dimensional unitary operators representing 1-qubit gates. Such matrices can be interpreted as performing conditional operations on qubits, i.e., the operations performed on one set of qubits is dependent upon the bit-values of another set of qubits. With this insight, they can be mapped immediately into an equivalent quantum circuit involving only 1-qubit rotations about the x-, y- and z-axes, 1-qubit phase shifts, and a standard 2-qubit gate, such as controlled-NOT (CNOT), the square root of SWAP (sqrt(SWAP)), or iSWAP. One can pick whichever two 2-qubit gate primitive one wants and obtain different factorizations accordingly. The significance of this is that different types of quantum hardware used for implementing quantum computers find it easier to achieve one of these 2-qubit gates than another. Correspondingly, the circuit can be optimized for the selected quantum hardware. Non-linear optics schemes can implement CNOT gates, spin-based quantum dot scheme can implement sqrt(SWAP) gates and charge-based schemes can implement iSWAP easily. The invention can thus be tailored to output circuit designs suited to many different quantum computing hardware implementations.

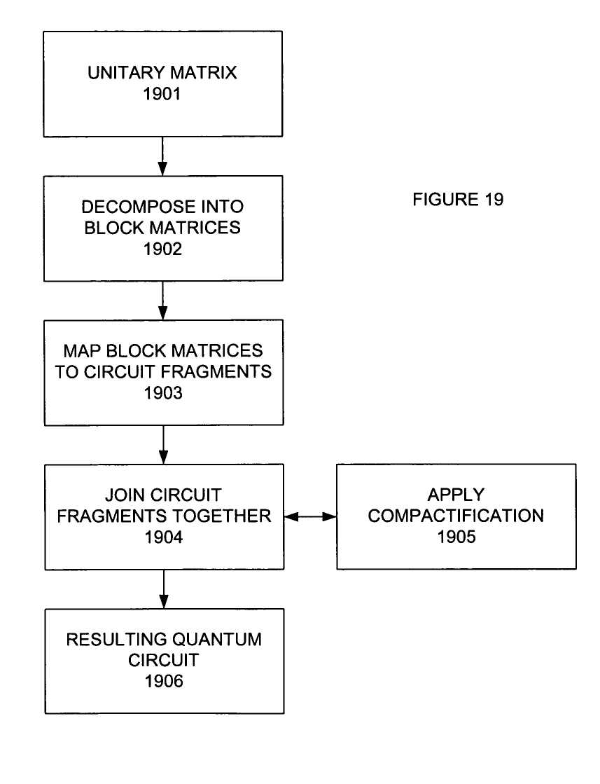

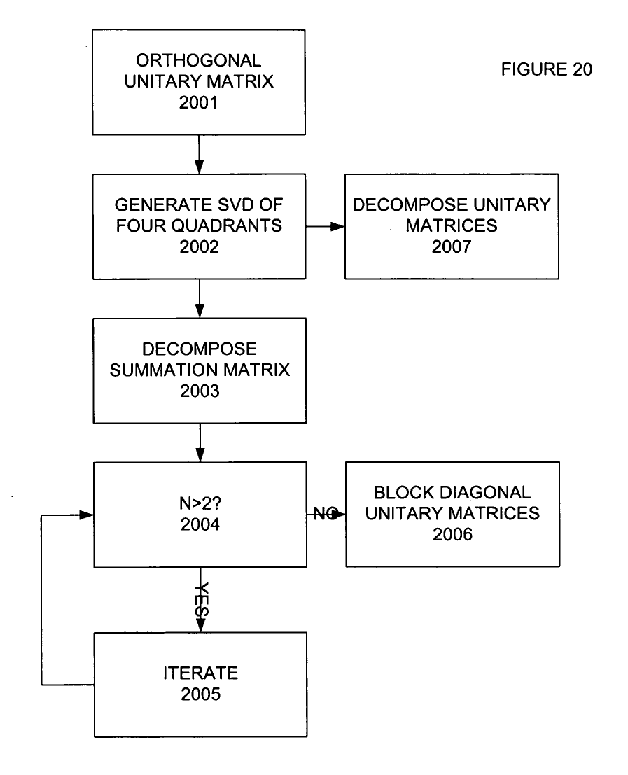

The present invention is described in connection with a 2ⁿ×2ⁿ dimensional unitary operator and its operation can be seen in the flow diagram of FIG. 19. Initially, the 2ⁿ×2ⁿ dimensional unitary operator (step 1901) is decomposed (step 1902) into a product of 2ⁿ×2ⁿ block-diagonal matrices, and direct sums of bit-reversal matrices (these need not be implemented explicitly). Next the block-diagonal matrices are mapped into corresponding quantum circuit fragments (step 1903). Each involves only one-qubit rotations about the y and z axes, one-qubit phase shifts, and a standard two-qubit gate, such as CNOT, the square root of SWAP, or iSWAP. (Note that whichever primitive two-qubit gate is selected results in different quantum circuits accordingly). Next the quantum circuit fragments are joined together (step 1904), while again applying compactification rules to minimize the size of the resulting circuits (step 1905). The result is a quantum circuit (step 1906) capable of implementing any (real or complex) unitary matrix, specialized to use one of several types of two-qubit gates, appropriate for different physical implementations of quantum computing hardware.

Our procedure relies in one embodiment upon the Generalized Singular Value Decomposition (GSVD). The GSVD recognizes that the SVDs of the four quadrants of an orthogonal matrix (step 2001) are highly inter-related to one another. In particular, if we have a unitary matrix U, of dimension 2ⁿ×2ⁿ, where n is the number of qubits, the GSVD yields:

$$U = ( \begin{matrix}{L}_{1} & 0 \\ 0 & {L}_{2}\end{matrix} ) ( \begin{matrix}{\sum }_{11} & {\sum }_{12} \\ {\sum }_{21} & {\sum }_{22}\end{matrix} ) ( \begin{matrix}{R}_{1} & 0 \\ 0 & {R}_{2}\end{matrix} )$$

(step 2002) where the L₁, L₂, R₁, and R₂ blocks are 2ⁿ⁻¹×2ⁿ⁻¹ unitary matrices, and the matrix Σ is a tri-banded unitary matrix as with Σᵢⱼ s are all diagonal matrices. The Σ matrix can be further decomposed (step 2003) into a product of two qubit-reversal operations and a block-diagonal unitary matrix with blocks representing one-qubit elementary gate operations:

$$( \begin{matrix}{\sum }_{11} & {\sum }_{12} \\ {\sum }_{21} & {\sum }_{22}\end{matrix} ) = {P}_{{2}^{n}}^{- 1} ( \begin{matrix}{\sum }_{11}^{′} & 0 & ⋯ & 0 \\ 0 & {\sum }_{22}^{′} & ⋯ & 0 \\ ⋮ & ⋮ & ⋰ & ⋮ \\ 0 & 0 & ⋯ & {\sum }_{{2}^{n - 1} {2}^{n - 1}}^{′}\end{matrix} ) {P}_{{2}^{n}}$$

where P₂ⁿ is a qubit reversal matrix which is composed of cascaded SWAP gates, and Σ₁₁, Σ₂₂ etc, are 2×2 unitary operations that can be expressed as R_{y}-rotations.

If n>2 (step 2004), the decomposition can be iterated (step 2005). The four unitary sub-blocks can be further decomposed (step 2007) until all resulting matrices are block-diagonal unitary matrices (step 2006), with blocks representing 1-qubit elementary gates. For example, further decomposing L₁ and L₂ above

$${L}_{1} = ( \begin{matrix}{L}_{1}^{′} & 0 \\ 0 & {L}_{2}^{′}\end{matrix} ) {P}_{{2}^{n - 1}}^{- 1} ( \begin{matrix}{\sum }_{11}^{′} & 0 \\ 0 & {\sum }_{22}^{′}\end{matrix} ) {P}_{{2}^{n - 1}} ( \begin{matrix}{R}_{1}^{′} & 0 \\ 0 & {R}_{2}^{′}\end{matrix} )$$

$${L}_{2} = ( \begin{matrix}{L}_{1}^{′′} & 0 \\ 0 & {L}_{2}^{′′}\end{matrix} ) {P}_{{2}^{n - 1}}^{- 1} ( \begin{matrix}{\sum }_{11}^{′′} & 0 \\ 0 & {\sum }_{22}^{′′}\end{matrix} ) {P}_{{2}^{n - 1}} ( \begin{matrix}{R}_{1}^{′′} & 0 \\ 0 & {R}_{2}^{′′}\end{matrix} )$$

Rejoing L₁ and L2, we obtain:

$${L}_{1} = ( \begin{matrix}{L}_{1} & 0 \\ 0 & {L}_{2}\end{matrix} ) = ( \begin{matrix}\begin{matrix}{L}_{1}^{′} & 0 \\ 0 & {L}_{2}^{′}\end{matrix} & 0 \\ 0 & \begin{matrix}{L}_{1}^{′′} & 0 \\ 0 & {L}_{2}^{′′}\end{matrix}\end{matrix} ) ( I ⊗ {P}_{{2}^{n}}^{- 1} ) ( \begin{matrix}\begin{matrix}{\sum }_{11}^{′} & 0 \\ 0 & {\sum }_{22}^{′}\end{matrix} & 0 \\ 0 & \begin{matrix}{\sum }_{11}^{′′} & 0 \\ 0 & {\sum }_{22}^{′′}\end{matrix}\end{matrix} ) ( I ⊗ {P}_{{2}^{n}} ) ( \begin{matrix}\begin{matrix}{R}_{1}^{′} & 0 \\ 0 & {R}_{2}^{′}\end{matrix} & 0 \\ 0 & \begin{matrix}{R}_{1}^{′′} & 0 \\ 0 & {R}_{2}^{′′}\end{matrix}\end{matrix} )$$

where I is the 2×2 identity matrix. This process can be repeated until each matrix is block-diagonal, in which the blocks are 2×2 unitary matrices representing arbitrary 1-qubit gates. In turn, each of the 1-qubit gates can be decomposed into four independent operations by application of the following lemma: Every 2×2 unitary matrix can be factored as a product of two R_{z} rotations, one R_{y} rotation and one phase shift

$$( \begin{matrix}{ⅇ}^{ⅈ δ} & 0 \\ 0 & {ⅇ}^{ⅈ δ}\end{matrix} ) ( \begin{matrix}{ⅇ}^{ⅈ α / 2} & 0 \\ 0 & {ⅇ}^{- ⅈ α / 2}\end{matrix} ) ( \begin{matrix}cos ( θ / 2 ) & sin ( θ / 2 ) \\ - sin ( θ / 2 ) & cos ( θ / 2 )\end{matrix} ) ⨯ ( \begin{matrix}{ⅇ}^{ⅈ β / 2} & 0 \\ 0 & {ⅇ}^{- ⅈ β / 2}\end{matrix} ) ≡ Ph ( δ ) \cdot {R}_{x} ( α ) \cdot {R}_{y} ( θ ) \cdot {R}_{z} ( β ) ,$$

where, alpha, theta, and beta, and delta are real valued. If the unitary matrix has unit determinant, the phase gate can be dropped. Hence, any 2ⁿ×2ⁿ dimensional block-diagonal unitary matrix, whose blocks are 2×2 unitary matrices, can be decomposed into the product of (at most) four simpler 2ⁿ×2ⁿ dimensional unitary matrices corresponding to purely phase shifts, z-rotations, or y-rotations.

The next step is to map each of these (“purified”) block diagonal matrices into an equivalent quantum circuit fragment. The concatenation of all such fragments, interleaved with compactification rules, yields a complete quantum circuit for U.

Mapping Block Diagonal Matrices into Circuit Fragments

One embodiment of the invention uses a recursive algebraic scheme for constructing a quantum circuit decomposition of an arbitrary unitary operator, interleaved with circuit compactification rules that reduce the complexity of the final quantum circuit. As noted, we decompose the 2ⁿ×2ⁿ dimensional unitary operator into a product of 2ⁿ×2ⁿ dimensional block-diagonal matrices, and direct sums of bit-reversal matrices (which need never be implemented explicitly). Next we map these block-diagonal matrices into corresponding quantum circuit fragments, each involving only 1-qubit rotations about the y- and z-axes, 1-qubit phase shifts, and a standard two-qubit gate, such as CNOT, \sqrt{SWAP}, or iSWAP. One can pick whichever primitive 2-qubit gate one wants and obtain different quantum circuits accordingly. The last step is to join these quantum circuit fragments together, while applying circuit compactification rules to minimize the size of the resulting circuit. The net result is a quantum circuit capable of implementing any (real or complex) unitary matrix, specialized to use one of several types of 2-qubit gates, appropriate for different physical implementations of quantum computing hardware.

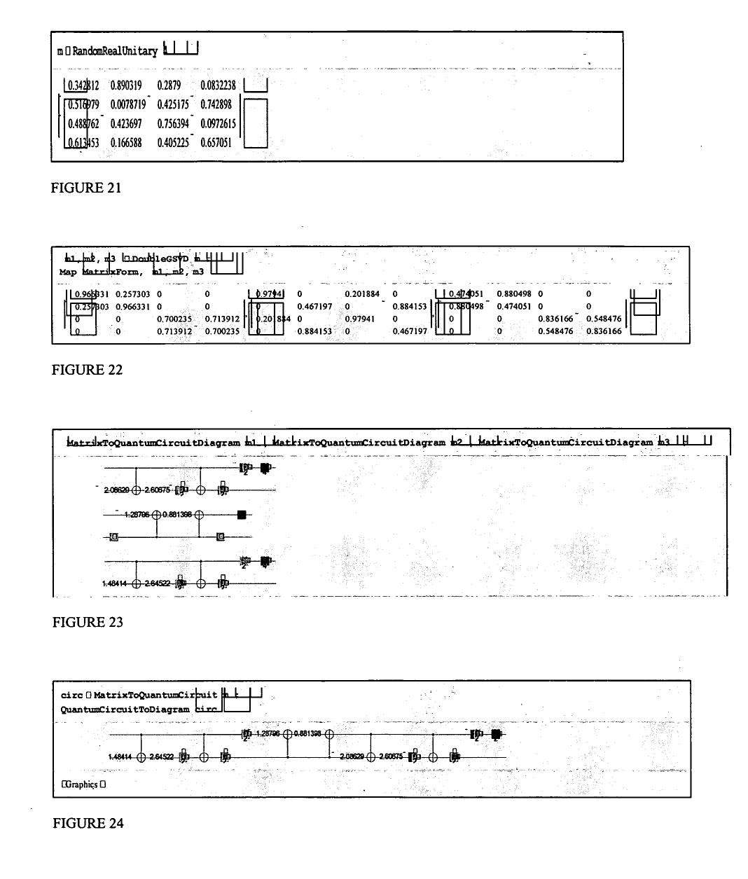

An example for a random real 4×4 unitary matrix is shown in FIGS. 21-24 to illustrate the procedure. FIG. 21 illustrates a random unitary matrix. In FIG. 22, using techniques of the invention, the matrix of FIG. 21 has been decomposed into the product of three other unitary matrices. The matrices on the far left and far right of FIG. 22 are block diagonal unitary matrices. FIG. 23 illustrates three quantum circuits that correspond (from top to bottom) to the three matrices (from left to right) of FIG. 22.

As can be seen in FIG. 23, the form for the first circuit and third circuit are the same, because you are decomposing block diagonal matrices in both cases. The middle circuit of FIG. 23 is different because it is a mapping of the tri-banded middle matrix of FIG. 22. FIG. 24 illustrates a concatenation of the three circuits of FIG. 23.

Different types of block diagonal matrices factorize into different circuit fragments. Consider a 4×4 block-diagonal unitary matrix, R, in which the blocks are y-rotations about different angles. As a matrix, R is expressed as:

$$R = ( \begin{matrix}{R}_{y} ( {θ}_{1} ) & 0 \\ 0 & {R}_{y} ( {θ}_{2} )\end{matrix} )$$

Intuitively, we can create R from two simpler operators, one which applies the same angular rotation to both the upper left and lower right quadrants, and another which applies opposing angular rotations to the upper left and lower right quadrants. For appropriately chosen angles, the product of such operations can achieve any desired angular pair. Thus, we consider:

$$I ⊗ {R}_{y} ( α ) = ( \begin{matrix}{R}_{y} ( α ) & 0 \\ 0 & {R}_{y} ( α )\end{matrix} ) , \\ CNOT ( I ⊗ {R}_{y} ( β ) ) CNOT = ( \begin{matrix}{R}_{y} ( β ) & 0 \\ 0 & {R}_{y} ( - β )\end{matrix} )$$

We can achieve R provided α+β=θ₁ and α−β=θ₂. Hence,

$$α = \frac{{θ}_{1} + {θ}_{2}}{2} , β = \frac{{θ}_{1} - {θ}_{2}}{2}$$

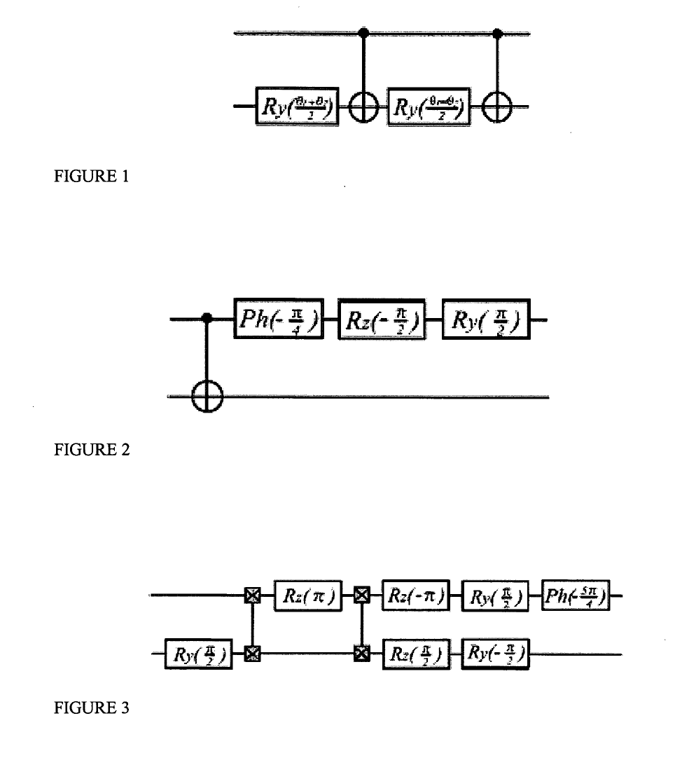

The quantum circuit representing R is as shown in FIG. 1. Angular rotation gates 103 and 104 represent the rotation about y of alpha and beta respectively. Control qubits 101 and 102 are atop controlled NOT (CNOT) gates 105 and 106 respectively.

This solution can be generalized to the n-qubit case. Consider a 2ⁿ×2ⁿ block-diagonal matrix whose blocks are one-qubit R_{y} rotations through angles theta one to theta 2ⁿ⁻¹. The quantum circuit for such a matrix can be generated recursively as:

$${R}_{y} ( n , A ) = CNOT ( 1 , n ) \cdot ( I ⊗ {R}_{y} ( n - 1 , {A}_{1 - {2}^{n - 2}} ) ) ⨯ CNOT ( 1 , n ) \cdot ( I ⊗ {R}_{y} ( n - 1 , {A}_{{2}^{n - z} + 1 \to {2}^{n - 1}} ) ) , \\ where A = ( \begin{matrix}{A}_{1} \\ ⋮ \\ {A}_{{2}^{n - 1}}\end{matrix} ) = {W}^{⊗ ( n - 1 )} ( \begin{matrix}{θ}_{1} \\ ⋮ \\ {θ}_{{2}^{n - 1}}\end{matrix} ) , the operator W = \frac{1}{2} ( \begin{matrix}1 & 1 \\ 1 & - 1\end{matrix} ) , and CNOT ( 1 , n ) is a controlled \text{-} NOT gate between the first and n \text{-} th of n \text{-} qubits .$$

A similar construction applies to the case of the direct sum of many R_{z} rotations through different angles. Hence, a 2ⁿ×2ⁿ block-diagonal matrix whose blocks are one-qubit R_{z} rotations through different angles can be mapped into a quantum circuit generated as:

$${R}_{z} ( n , A ) = CNOT ( 1 , n ) \cdot ( I ⊗ {R}_{z} ( n - 1 , {A}_{1 \to {2}^{n - 2}} ) ) ⨯ CNOT ( 1 , n ) \cdot ( I ⊗ {R}_{z} ( n - 1 , {A}_{{2}^{n - 2} + 1 \to {2}^{n - 1}} ) )$$

For the 4×4 block-diagonal unitary matrix Φ, in which the blocks are Ph-gates (phase gates) represented as:

$$Φ = ( \begin{matrix}Ph ( {θ}_{1} ) & 0 \\ 0 & Ph ( {θ}_{2} )\end{matrix} )$$

The quantum circuit achieving Φ is R_{z}(theta1−theta2)\textcircled{×}(Ph(theta1+theta2)/2). It follows that the quantum circuit fragment for a 2ⁿ×2ⁿ block-diagonal matrix whose blocks are one-qubit Ph gates can be defined recursively as:
Ph(n, A)=M₁·M₂·M₃
where
   M₁=I\textcircled{×}=Ph(n−1, A₂_{ⁿ⁻²}),
   M₂=R_{z}(A₂_{ⁿ⁻²}₊₁)\textcircled{×}I\textcircled{×} . . . \textcircled{×}I,
   M₃=CNOT\textcircled{×}R_{z}(A₂_{ⁿ⁻²}₊₂₋₂_{ⁿ⁻¹})\textcircled{×}CNOT

Hence, all three primitive types of 2ⁿ×2ⁿ dimensional block-diagonal matricies can be mapped into corresponding quantum circuit fragments, which use only CNOT gates, and one-qubit Ph, R_{y}, and R_{z} operations.

To complete the decomposition we concatenate the circuit fragments, and apply final compactification in an attempt to minimize the overall circuit complexity. The compactification rules eliminate unnecessary gate operations including rotations and phase shifts through an angle of zero or 2nπ, combine contiguous sequences of Ph-, R_{y}-, or R_{z}-gate operations, accumulate phase gates into an overall phase, compress sequences of CNOT gates having the same embedding, and implement bit-reversals by explicitly rewiring the circuit (rather than implementing such operations computationally). These compactification rules are found to reduce the complexity of the final quantum circuit significantly. Specifically, whereas previous algebraic schemes would always result in exponentially large circuits, the invention does not: Unitary operators having a direct product structure are mapped to compact quantum circuits, real unitary operators are mapped into smaller circuits than complex unitary operators, and known “special case” unitary operators (such as the QFT) are found to have smaller circuits than random unitary operators.

For example, the unitary operator generated by the Hamiltonian in Mermin's version of the Bell-Kochen-Specker Theorem is

$$\frac{1}{\sqrt{2}} ( \begin{matrix}- ⅈ & 0 & 0 & 1 \\ 0 & - ⅈ & 1 & 0 \\ ⅈ & 0 & 0 & 1 \\ 0 & ⅈ & 1 & 0\end{matrix} )$$

FIG. 2 illustrates the corresponding quantum circuit for the operator above. Control qubit 201 is atop CNOT gate 202. In left to right time from the control qubit is Ph gate 203, rotation gate 204 (for R_{z}) and rotation gate 205 (for R_{y}).

Replacing CNOT with the square root of SWAP yields the circuit of FIG. 3. On the bottom line, rotation gate 301 leads through quantum NOT gate 303 to Not Gate 309. This is followed by rotation gates 310 and 311. On the top line NOT gate 302 is followed by rotation gate 304 and NOT gate 305. Rotation gates 306, 307, and 308 follow gate 305.

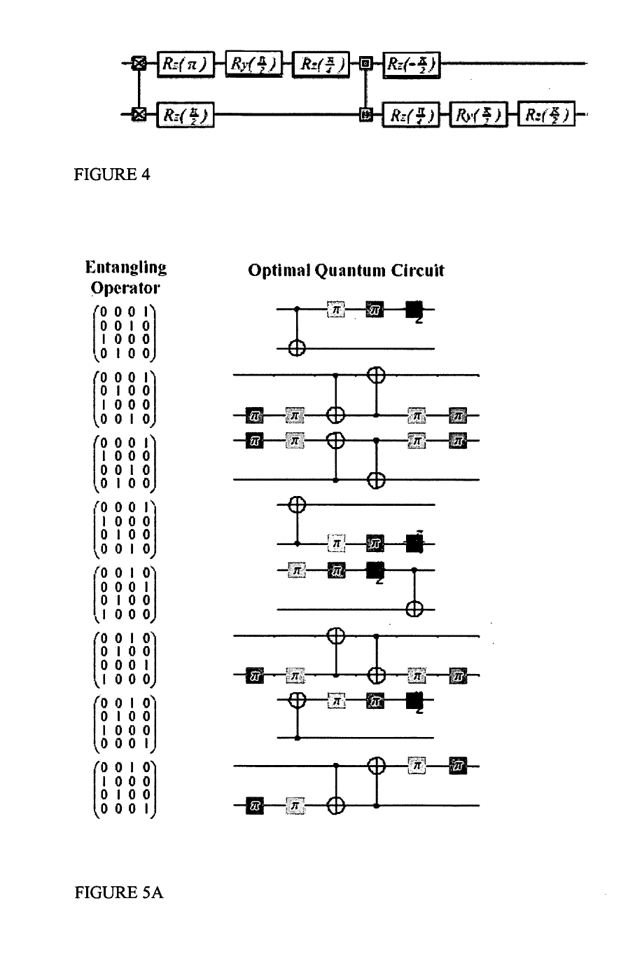

Replacing CNOT with iSWAP and iSWAP⁻¹ yields the circuit of FIG. 4. On the top line, NOT gate 401 leads to rotation gates 402, 403, and 404. Identity gate 405 follows and leads to rotation gate 406. The bottom line has NOT gate 407 leading through rotation gate 408 to identity gate 409, followed by rotation gates 410, 411, and 412.

To be physically realizable, a quantum algorithm should be decomposable into an equivalent quantum circuit, i.e., a sequence of 1-qubit and 2-qubit quantum logic gates that preferably, are easiest to implement in a particular physical context. It is also desired to tailor the decomposition of a unitary transformation to fit the chosen physical hardware, rather than to wrestle the physics to fit an ad hoc model of computation. The present invention describes a general recursive algebraic quantum circuit decomposition for systematically constructing such circuits involving only one-qubit rotations about the y- and z-axes, one-qubit phase shifts, and a standard two-qubit gate, such as CNOT, the square root of SWAP, or iSWAP. One can pick whichever primitive two-qubit gate one wants and obtain different quantum circuits accordingly. In one embodiment, the circuit should contain a number of gates that grows only polynomially with the number of qubits. However, for most unitary matrices this is not likely because it takes N² real numbers to specify an arbitrary N×N unitary matrix. Hence, it should be expected for the quantum circuit to require O(N²) quantum gates.

Compactification

The present invention also provides compactification techniques for reducing the number of gates. One embodiment applies deterministic circuit reduction operators to look for a pattern among sub-circuits and/or gates that can be eliminated or rewritten to a more compact gate. Another embodiment computes the circuit for a particular unitary matrix U and also computes the circuit for the inverse matrix of U. These two computed circuits are then examined to determine which is smaller and that circuit is used. Another embodiment is referred to as randomized compactification that uses a heuristic approach to arrive at a compact circuit.

It is known that any n-qubit quantum computation can be achieved using some sequence of 1-qubit and 2-qubit quantum logic gates. However, it is not yet known how to compute the optimal (i.e., smallest depth, fewest gate count) circuit with respect to a particular family of universal gates for arbitrary n-qubit quantum computations apart from using exhaustive circuit template enumeration, which rapidly becomes intractable with increasing n.

Previous work on optimal quantum circuit design has been limited to specially structured unitary matrices, such as decompositions of conditional quantum logic gates into circuits comprising 1-qubit and CNOT gates, and to completely general 2-qubit quantum computations. However, it is not clear how these techniques can be generalized for arbitrary n-qubit computations.

This invention provides a technique for constructing compact quantum circuits for arbitrary n-qubit quantum computations. One embodiment uses an algebraic quantum circuit design technique based on the Generalized Singular Value Decomposition, interleaved with rewrite rules for recognizing and eliminating sources of gate inefficiency. Another embodiment uses a non-deterministic circuit reduction procedure that is found to be effective at eliminating unnecessary complexity from an extant quantum circuit, often converging on the optimal circuit.

Algebraic Quantum Circuit Design

There are a number of embodiments to compute a quantum circuit sufficient to realize an arbitrary n-qubit quantum computation. Of these, algebraic techniques, such as the progressive matrix diagonalization of Reck, the “quantum Givens” operations of Cybenko, the hierarchical CS decomposition of Tucci, or the recursive Generalized Singular Value Decomposition of an embodiment of the invention are appealing because the method is systematic and constructive. However, if done naively, would result in circuits that contain exponentially many gates and therefore unacceptable on their own. This invention describes embodiments of appropriate compactification rules that result in manageable and practical numbers of gates.

The invention in one embodiment works as follows. First decompose a given 2ⁿ×2ⁿ dimensional unitary matrix representing the desired computation into a product of block-diagonal matrices, and direct sums of bit-reversal matrices (which need never be implemented explicitly). Next map these blockdiagonal matrices into corresponding quantum circuit fragments as described herein, each involving only 1-qubit rotations about the y- and z-axes, 1-qubit phase gates, and a standard 2-qubit gate, such as CNOT, square root of SWAP, or iSWAP. One can pick whichever primitive 2-qubit gate one wants and obtain different quantum circuits accordingly. Finally, join these quantum circuit fragments together, while again applying compactification rules to minimize the size of the resulting circuit.

The net result is a quantum circuit capable of implementing any (real or complex) unitary matrix, specialized to use one of several types of two-qubit gates, appropriate for different physical implementations of quantum computing hardware.

Mixed State Synthesis

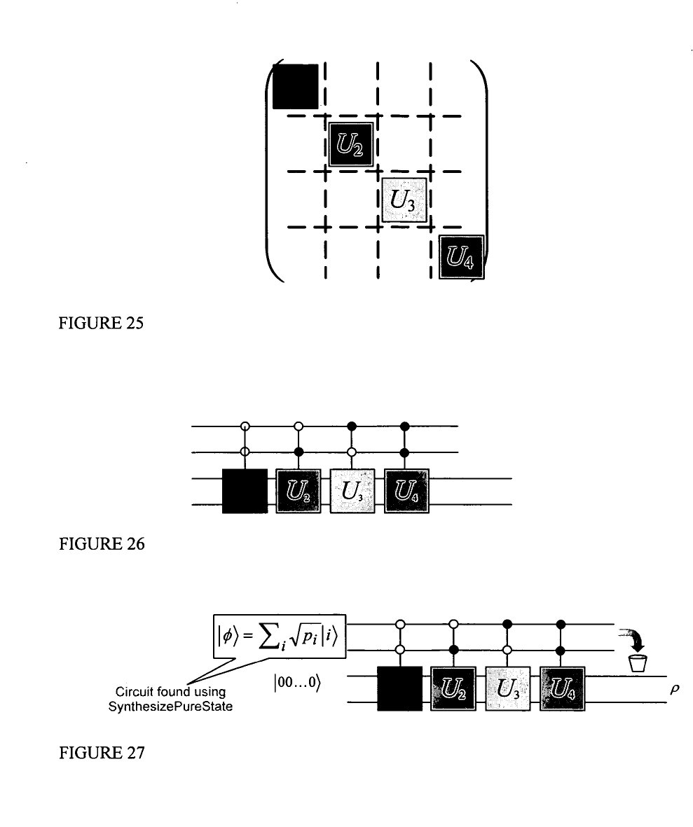

The present invention provides mixed state synthesis by using the spectral decomposition of the desired mixed state to identify a set of unitary matrices sufficient to synthesize the necessary eigenvectors found in the spectral decomposition. Then, these unitary matrices are combined, via their direct sum, into a conditional quantum logic circuit. Finally, a loaded dice state such as |φ [symbol] =Σᵢ\sqrt{Pᵢ}|i [symbol] is synthesized weighted in proportion to the representation of each eigenvector in the mixed state. Our mixed state synthesis scheme exploits the correspondence between a unitary matrix built from the direct sum of smaller unitary matrices, and an equivalent conditional quantum logic circuit. For example, the unitary matrix shown in FIG. 25 is equivalent to the conditional quantum logic circuit shown in FIG. 26. FIG. 25 illustrates a block diagram of unitary matrices U₁, U₂, U₃, and U₄. The matrix 2501 represents a 16×16 unitary gate so that each of the inner blocks represents a 4×4 unitary matrix. As such they correspond to 2 qubit gate operations. FIG. 26 represents a conditional quantum circuit that uses those matrices. For example, there are a pair of control qubits above each matrix of FIG. 26. Some of the control qubits are shown closed and some open. In the example, those control qubits represent the conditions for the controlled unitary matrix to act upon the qubits entering the controlled matrix. In FIG. 26, an open control qubit represents a zero and a closed control qubit represents a one. So both control qubits of unitary matrix U₁ would have to be zero for matrix U₁ to act on the qubits entering the matrix. Similarly, for matrix U₂, the top control qubit would need to be zero and the bottom control qubit would need to be 1 for matrix U₂ to act on entering qubits.

The input state |φ [symbol] in the current version of the figure is a special case application of the conditional circuit to make a mixed state as illustrated in FIG. 27.

Compactification Via Rewrite Rules

Assume a quantum circuit sufficient to realize a desired n-qubit quantum computation has been found. It is now desired to “optimize” the circuit so that the n-qubit operation can be accomplished using the fewest quantum gates, or rather, the fewest 2-qubit quantum gates (such as CNOT gates) as these are generally considered by experimentalists to be harder to make than 1-qubit gates. One approach is to develop a rewrite rule system for quantum circuits. This system is independent of how the original quantum circuit was derived.

Term rewriting is a general purpose technique used in automated theorem proving. In one embodiment, the rewrite rule system is “Canonical” and “Church-Rosser”. “Canonical” means that equivalent expressions are rewritten to a common form. “Church-Rosser” means that some measure of the structural complexity of the expression being rewritten is reduced after each rule invocation.

As an example, we consider applying the rewrite rules of the invention to simplify 2-qubit quantum circuits. The circuit design technique described herein reduces any nqubit quantum computation to sequences of 1-qubit gates and CNOT gates. Thus, by grouping CNOT gates with the surrounding 1-qubit gates that share the same embedding, i.e., act on the appropriate control and target qubits, we can regard the entire n-qubit circuit as a sequence of overlapping 2-qubit gates. By compactifying these two qubit gates we systematically reduce the complexity of the overall n-qubit operation.

One embodiment of the invention applies rules obtained using permutation matrices.

Rules Discovered Using Permutation Matrices

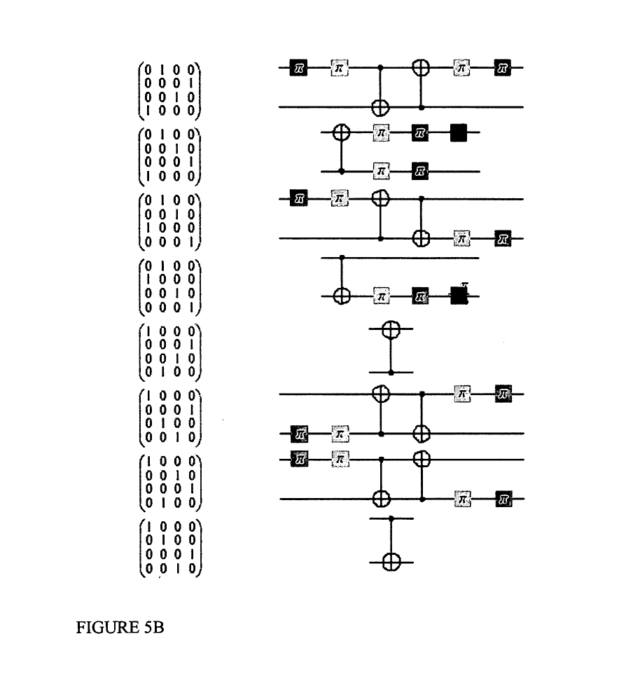

Permutation matrices are a special class of 4×4 unitary matrices possessing a single 1 in each row and column. Of the 4!=24 possible permutation matrices, 16 are maximally entangling operations and 8 are non-entangling operations. In FIGS. 5A and 5B, we show the optimal quantum circuit for each maximally-entangling permutation matrix. Here, light gray, darker gray, and darkest gray boxes correspond to rotations about the y-axis, z-axis, and phase gates, respectively. The numbers in the boxes are the angle in radians through which the rotation is performed. This is expressed as a decimal number in some cases, or as a function of π in other cases.

The optimal circuits in FIGS. 5A and 5B were found using a numerical technique that incrementally explores circuit templates of increasing complexity until the simplest sufficient template is found. This is feasible for 2-qubit gates but not, in general for n-qubit gates, due to the exponentially growing number of possible templates to try.

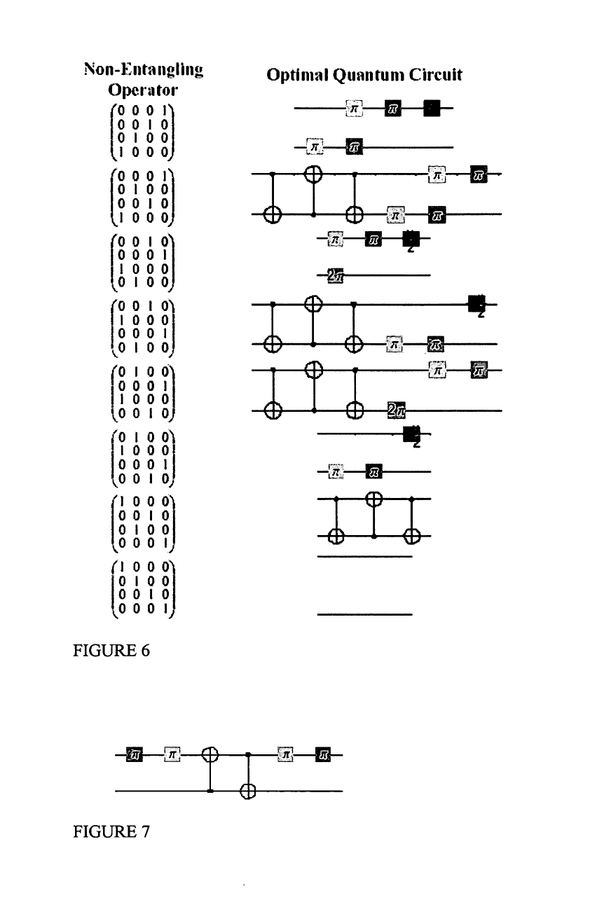

Similarly, the invention can compute optimal circuits for the remaining 8 non-entangling operations as shown in FIG. 6. We first compute the entangling power of the unitary operator. If this is zero this suggests that the unitary operator is either a direct product of 1-qubit gates or equivalent to a SWAP gate up to 1-qubit gates. In this case, we apply an “inverse direct product” procedure that finds optimal circuits using an algebraic construction without the need for any numerical optimization. If the inverse direct product construction yields a factorization that involves non-unitary matrices, this indicates that the factorization as a direct product of 1-qubit gates is invalid. In this case, operating with a SWAP gate will make a gate that is a direct product of 1-qubit gates. Although all of these operations are non-entangling, some of them require the use of several 2-qubit gates, e.g., the SWAP gate factors into three consecutive CNOTs.

Given that we now have known optimal circuits for the 2-qubit permutation matrices, we effectively have a standard against which to assess the efficiency of the circuits returned from other more generic circuit construction procedures. In particular, if we construct a quantum circuit for any matrix for which an optimal decomposition is known, then if the procedure returns a longer than necessary circuit we can immediately extract a useful rewrite rule from the discrepancy.

Typically, general-purpose algebraic techniques do not spot, or exploit, the special structure present in many useful unitary operators and will return a circuit containing gates having “special” angles, such as y- or z-rotations through multiples of π. The goal in identifying rewrite rules is in finding the smallest most general rewrite from each such case. Once one such a rule is found, symmetry arguments suggest similar rules. The process can thus be automated to allow a machine to accumulate useful rewrite rules through trial and error.

For example, below we show three quantum circuits found for the same permutation matrix, namely the matrix;

$$( \begin{matrix}0 & 0 & 0 & 1 \\ 1 & 0 & 0 & 0 \\ 0 & 0 & 1 & 0 \\ 0 & 1 & 0 & 0\end{matrix} )$$

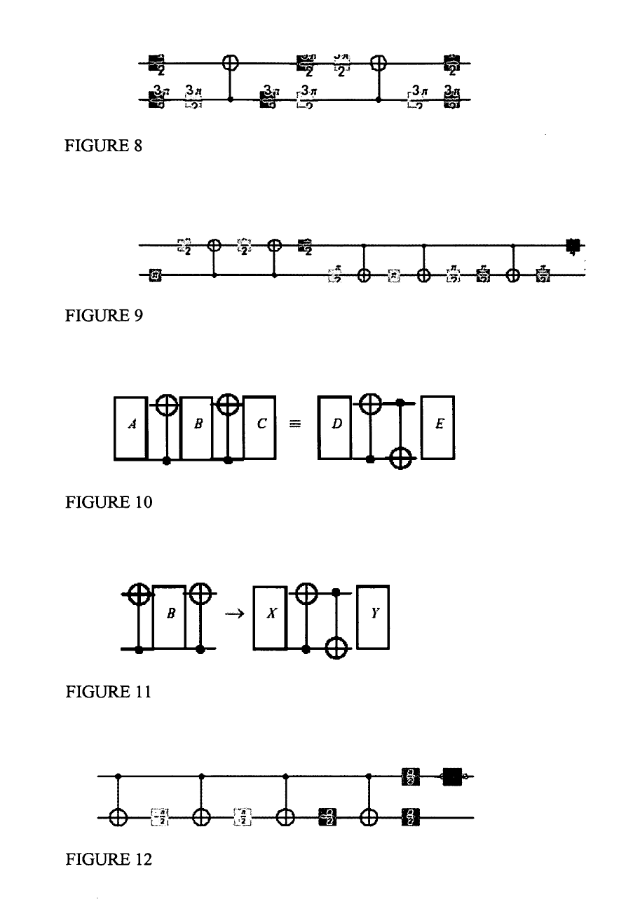

The optimal circuit for the matrix is shown in FIG. 7. Two alternate circuits implementing the same unitary operation are shown in FIGS. 8 and 9. The circuit in FIG. 7 is clearly more efficient than the circuits of FIGS. 8 and 9.

To extract a useful rewrite rule from these observations the invention creates a rule that is general. The invention identifies the principle behind a simplification. In this case, we wish to attract CNOTs together.

Viewed in this way, we wish to rewrite a circuit of the form on the left of FIG. 10 into one of the form on the right of FIG. 10, with the CNOTs abutting one another.

Thus the rewrite rule we want to extract from this is a rule that “attracts” CNOT gates together in a quantum circuit. Hence, we maneuver the 1-qubit gates on the left hand side of the circuit equality and compactify, to yield a final rule of the form illustrated in FIG. 11

where X=A⁻¹ D and Y=EC⁻¹ with subsequent quantum gate compactification.

To ensure that the rewrite rules have the wide applicability, an embodiment favors small rewrite rules over larger ones. In addition, after several rewrite rules have been learned we attempt to induce a general rule that encompasses them. In this way we systematically inflate and then rationalize the set of rewrite rules.

Rules Discovered Using Other Sparse Unitaries

If we replace some or all of the 1's in a 4×4 permutation matrix, with ±1±i, we arrive at other sparse unitary matrices. We can repeat the aforementioned procedure: using an (unoptimized) algebraic technique to compute a raw quantum circuit for the desired unitary, and again compare it against a known optimal circuit. For example, with compactification turned off, an algebraic circuit design system would not recognize certain transformations, e.g., e^{iα} CNOT with α=0.12345, as a simple form. In fact, naively, it would return the factorization shown in FIG. 12.

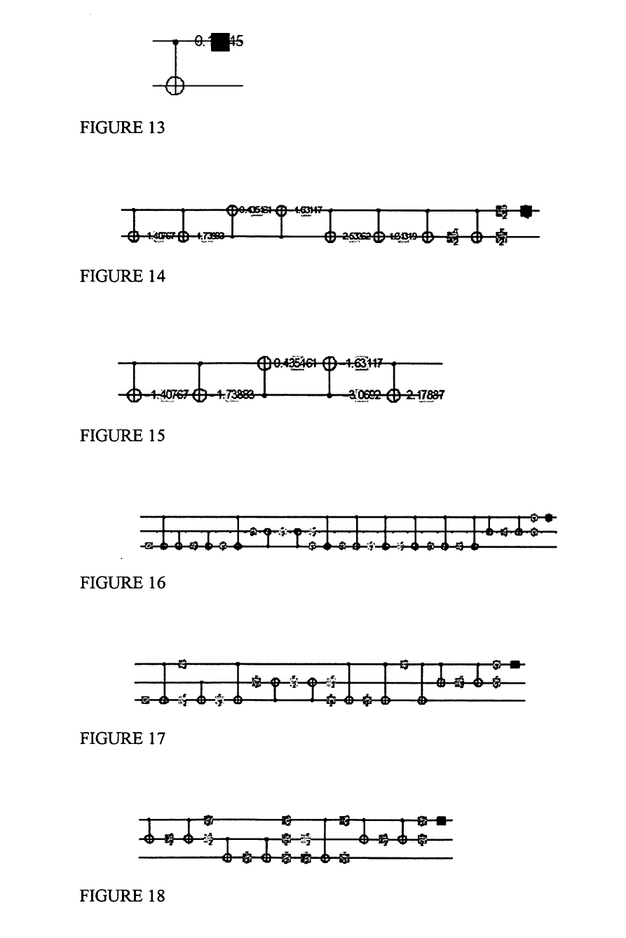

However, it is relatively easy to learn rewrite rules that spot the fingerprint of such global phases and hence avoid such naïve decompositions. In fact, the invention described herein returns the correct optimal circuit for such matrices, i.e. that shown in FIG. 13.

Deterministic Compactification

The quantum circuit design tool of the invention attempts to find the smallest circuit for a given unitary operator, U, by applying circuit compactification rules. These eliminate unnecessary gates from the circuit while preserving its correctness. For example, before rule application we might obtain a circuit such as shown in FIG. 14.

After we apply circuit compactification, this circuit can be simplified to be of the form as shown in FIG. 15. The rewrite rules succeeded in eliminating three CNOT gates, three z-rotation gates, and a phase gate.

Another way in which circuits can be compactified is by computing the circuit decomposition of a desired unitary operator, U, together with the circuit for its inverse, U^{\}. If the circuit for U is smaller, then we are done, else the circuit for U^{\} is smaller, in which case we negate the angles, and read the gates in the opposite direction.

Non-Deterministic Compactification

We can continue applying our rewrite rules until the circuit no longer changes, i.e., cannot be simplified further. However, this does not necessarily mean further compactification is impossible, even using the same set of rewrite rules. One embodiment of the invention uses the current best (most compact) circuit and cuts it at two random points, maps the gates between those points back into a unitary operator, and then redesigns a quantum circuit for that operator, ans performs a fresh round of compactification on the new sub-circuit. If the resulting subcircuit is smaller than the circuit that was excised, then accept it, else pick a new pair of random cut points and repeat.

The randomized non-deterministic compactification scheme of this embodiment of the invention is effective at finding further compactifications of quite complex circuits. For example, here is a 3-qubit quantum computation represented by the unitary operator:

$$( \begin{matrix}1 & 0 & 0 & 0 & 0 & 0 & 0 & 0 \\ 0 & 0 & 0 & 1 & 0 & 0 & 0 & 0 \\ 0 & 0 & 1 & 0 & 0 & 0 & 0 & 0 \\ 0 & 1 & 0 & 0 & 0 & 0 & 0 & 0 \\ 0 & 0 & 0 & 0 & 0 & 0 & 0 & 1 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0\end{matrix} )$$

The raw output from an algebraic decomposition (with compactification turned off) would be the quantum circuit shown in FIG. 16.

After deterministic rewite rules have been applied, the output would be reduced to the circuit of FIG. 17.

After running the randomized non-deterministic compactification procedure, using exactly the same set of rewrite rules, a further reduction in complexity is achieved to that of FIG. 18.

One possible reason that randomized compactification is effective is because it breaks the boundaries of quantum circuit fragments generated under the algebraic decomposition procedure. This means that the randomized method explores subcircuit structures that were not explicitly generated, or compactified, during the decomposition.

Data Entry

To adapt this quantum circuit design tool for the purpose of data entry on a quantum computer, a number of steps are performed.:
(1) Step 1: Make the Bit String-Eigenstate Correspondence: Given a string of 2ⁿ classical bits, place these in 1-to-1 correspondence with the set of 2ⁿ n-bit eigenstates. For example, if the bit string were “0111”, the corresponding four 2-bit eigenstates would be “|00 [symbol] ”, “|01 [symbol] ”, “|10 [symbol] ”, “|11 [symbol] ” in order.
(2) Step 2: Map Bits to Superposition State: Construct an equally weighted superposition that is peaked at only those eigenstates which correspond to a “1” in the given bit string sequence (i.e. the classical data). For the bit string sequence (of length 4 bits) “0111” the corresponding 2-qubit state would be

$${2}^{n} classical bits \{ ( \begin{matrix}0 \\ 1 \\ ⋮ \\ 1\end{matrix} ) \to \frac{1}{\sqrt{l}} ( \begin{matrix}0 \\ 1 \\ ⋮ \\ 1\end{matrix} ) ≡ \underbrace{\frac{1}{\sqrt{l}} ( \vert 0 … 01 〉 + … + \vert 1 … 11 \text{〉} \text{)}}_{n qubits} = \vert ψ 〉$$

In general, this will be an entangled state of n quantum bits that encodes a specific sequence of 2ⁿ classical bits. Generalizing: the basic idea (when there are l “1'”s in the bit string of length 2ⁿ) we get:

$$\vert ψ 〉 = \frac{1}{\sqrt{3}} ( \vert 01 〉 + \vert 10 \text{〉} + \vert 11 〉 \text{)} .$$
(3) Step 3: Compute Unitary Transformation Needed to Make this Superposition State Starting From (Say) |00 . . . 0>: Induce a unitary matrix that will map the state |00 [symbol] (or actually any other easy-to-make state) into the state |ψ [symbol] , e.g, for the classical bit string “0111” the unitary matrix would be:

$$( \begin{matrix}0 & - 1 / \sqrt{3} & - 1 / \sqrt{3} & - 1 / \sqrt{3} \\ 1 / \sqrt{3} & 2 / 3 & - 1 / 3 & - 1 / 3 \\ 1 / \sqrt{3} & - 1 / 3 & 2 / 3 & - 1 / 3 \\ 1 / \sqrt{3} & - 1 / 3 & - 1 / 3 & 2 / 3\end{matrix} )$$

This is computed by calculating first |ψ [symbol] [symbol] ψ| (which gives us one column of the necessary matrix) and then generating the remaining orthonormal vectors for the other columns.
(4) Step 4: Compute the Quantum Circuit that Implements this Unitary Transformation: We use a circuit design tool to convert the desired unitary matrix into an equivalent (feasible) quantum circuit. For example, the circuit below implements the unitary matrix reported in Step 3 for this very small example. The yellow 1-qubit gates correspond to 1-qubit rotations about the y-axis using the indicated angles. The other 2-qubit gates are controlled-NOT gates, CNOT, inserted in one of two ways.

$${R}_{y} ( θ ) = ( \begin{matrix}cos ( \frac{θ}{2} ) & sin ( \frac{θ}{2} ) \\ - sin ( \frac{θ}{2} ) & cos ( \frac{θ}{2} )\end{matrix} ) , CNOT = ( \begin{matrix}1 & 0 & 0 & 0 \\ 0 & 1 & 0 & 0 \\ 0 & 0 & 0 & 1 \\ 0 & 0 & 1 & 0\end{matrix} )$$

Thus, a method and apparatus for automatic generation of quantum circuits is described in conjunction with one or more specific embodiments. The embodiments of the present invention are defined by the following claims and their full scope of equivalents.

We claim:

1. A method of generating a quantum circuit from a unitary matrix comprsing:
decomposing the unitary matrix into block matrices;
mapping each block matrix to one of a plurality of circuit fragments;
joining the circuit fragments while applying compactification to generate a quantum circuit.

2. The method of claim 1 wherein the block matrices are block diagonal matrices.

3. The method of claim 2 wherein decomposing the unitary matrix comprises generating the singular value decomposition (SVD) of four quadrants and resulting in block diagonal matrices and summation matrices.

4. The method of claim 3 wherein the summation matrix is decomposed iteratively to result in block diagonal unitary matrices.
